(19) United States
(12) Patent Application Publication
(10) Pub. No.: US 2009/0287324 A1
(43) Pub. Date: Nov. 19, 2009

(54) PORTABLE AUDIO ENHANCEMENT AND MEDIA PLAYER DEVICE

(75) Inventor: Yew Teng Too, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd, Singapore (SG)

(21) Appl. No.: 12/120,050

(22) Filed: May 13, 2008

(51) Int. Cl. G06F 17/00

(52) U.S. Cl. 700/94

(57) ABSTRACT

A portable audio enhancement and media player device and method are disclosed for enabling an electronic consumer product such as a personal computer, personal digital assistant (PDA), cellular phone or the like, to process and format media having different data formats such “wav” “mp3”, “mov”, “midi” files, and the like. The portable device may be connected to an electronic consumer product via a connector such as universal serial bus (USB), firewire, audio out, audio in, and the like. By connecting the portable device via one of the connectors, the portable device provides the required processors for processing audio/video media data necessary to play such data formats and enable the electronic consumer product with sound card and media player functionality. The portable device with media player functionality enables an electronic product such as a personal computer to obtain an additional secondary functionality such as audio enhancement when connected to the host computer and also aid in processing data when connected to the host computer.

### FIELD OF THE INVENTION

This invention relates generally to audio enhancement and media player devices, and more particularly to a portable device with media player functionality that enables an electronic product such as a personal computer to obtain enhanced audio output.

### BACKGROUND

The consumer electronics market includes different types of electronic devices such as personal computers, personal digital assistants (PDA), cellular phones, televisions, etc. that are equipped to playback media having different data formats. One of the most popular types of such consumer electronic devices is portable media playback devices. These portable media playback devices come in all sizes and offer a variety of functionalities. However, these portable media playback devices are typically stand-alone devices, and at the very most, also serve as an additional data storage device for a user. Such devices typically do not have any secondary functionality.

Additionally, even when these portable media playback devices are connected to a host computer for either data synchronization or data transfer, processing resources on these portable media playback device are not utilised.

Many personal computers and notebooks nowadays are equipped with embedded audio processing chips, and the quality of audio reproduction suffers as a capability of such embedded audio processing chips is lacking. There are thus many people who hanker for improved audio reproduction quality from their personal computers and notebooks which are equipped with such embedded audio processing chips.

Therefore, there is a need for a portable device with media player functionality which is able to provide an additional secondary functionality of audio enhancement when connected to the host computer and also aid in processing data when connected to the host computer.

### SUMMARY

An aspect of the invention is a portable media processing device for connecting with and enabling an external device with audio enhancement functionality, the portable device comprising a housing and a connector interface for connecting and exchanging data with the external device; a media player module for processing data; and a controller for identifying the data received from the external device and selectively controlling the media player module for processing the data from the external device and supplying the processed data.

An embodiment of the invention is a user interface port for connecting user interface devices. The user interface device may be selected from the group consisting of: speakers, earphones, headphones, displays, and monitors. The portable media processing device may further comprise a player module having an audio data processor, and a media data processor. The portable media processing device may further comprise data storage for storing the processed data. The controller may supply the processed data to either the external device or the user interface port. The connector interface may be a USB connector interface or a firewire connector interface. The external device may be a device selected from the group consisting of a notebook, a personal computer, a television, a mobile telephone, a games console, a camera, a CD player, and a DVD player. A portion of memory allocated for the processing of audio signals in the external device may be freed up for use by a processor in the external device and processing of non-audio related tasks in the external device is enhanced.

An aspect of the invention is a method for enabling an external device with audio enhancement functionality with a portable media processing device, the method comprising connecting the portable device to the external device; receiving data from the external device; identifying the data received from the external device; selectively controlling a media player module, the media player module configured for processing the data; and supplying the processed data to either the external device or a user interface port.

Another aspect of the invention is a media player device for processing media content. The media player device includes a controller and a media player module. The controller is configured to select between a first mode and a second mode, wherein the first mode is selected if audio data is absent in the media content and the second mode is selected if audio data is present in the media content. The first mode is operable to process the media content without audio enhancement processing and the second mode is operable to apply audio enhancement processing to the audio data. The media player module is configured to process media content according to the first mode and the second mode such that if the first mode is selected, the processed media content is suitable for playback on an output display, and such that if the second mode is selected, the processed media content is suitable for playback on an audio output device.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 illustrates a block diagram of a portable device in accordance with an embodiment of the invention; and

FIG. 2 illustrates a flow chart of a method in accordance with an embodiment of the invention.

### DETAILED DESCRIPTION

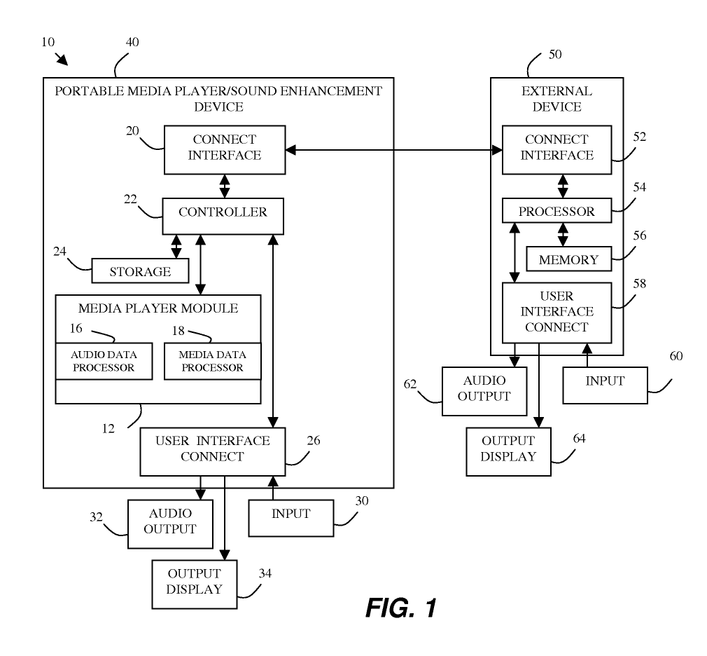

Referring to FIG. 1, a block diagram of a portable media processing device 10 is shown. The portable media processing device 10 connects with an external device 50 and enables the external device 50 with audio enhancement functionality. The external device 50 may be, for example, a notebook, a personal computer, a television, a mobile telephone, a games console, a camera, a CD player, a DVD player and so forth. The portable device 10 comprises housing 40 for a controller 22 and a storage 24 connected to the controller 22. The controller 22 is connected to a media player module 12. The media player module 12 has data processors 16,18. The portable device 10 has a connector interface 20 that connects to a corresponding connector interface 52 of the external device 50. Through the connector interfaces 20,52 the portable device 10 is able to exchange data with the external device 50 when the portable device 10 is connected to the external device 50.

The portable device 10 is able to function independently as a media playback device in a first mode when the portable device 10 is not connected to the external device 50. The controller 22 receives media data from the storage 24. Subsequently, the controller 22 identifies the media data and selectively controls the media player module 12 to process the data using at least one of the media data processor 18, and the audio data processor 16. The processed data is then sent back to the controller 22 and is subsequently sent to the user interface connect 26 for audio output 32 and display output 34. The audio output 32 may include, for example, speakers, earphones, headphones and so forth.

In a second mode, the controller 22 receives audio data from the external device 50. The controller 22 identifies the audio data received from the external device 50 and selectively controls the media player module 12 to process the data. The audio data may be processed using the audio data processor 16.

The data processed by the audio data processor 16 is returned to the controller 22 and may transmit the processed data either to the external device 50 or to a user interface connect 26 within the portable device 10. The user interface connect 26 may comprise a port or another connector for connecting external user interface devices. The external user interface devices include audio input 30, output devices 32 such as, for example, speakers, earphones, headphones and so forth. Other external user interface devices include output display devices 34 such as, for example, displays, monitors and the like.

The audio data processor 16 in the media player module 12 may enable the incorporation of advanced sound enhancement effects. These advanced effects cover a wide range including but not limited to 3D audio spatialization (virtualization) and transient enhancement. The portable device 10 is configured to receive an audio input signal through the connect interface 20, in analog or digital form, consequently enhance the received signal in media player module 12, and subsequently transmit an output audio signal through the user interface connect 26 having the enhanced effects embedded in the signal. The output signal may be either digital or analog. The output signal may be, for example, a mono signal, a stereo signal, a MIDI signal, or a multichannel signal (such as 2.1, 5.1, 7.1, etc.). In some embodiments, the audio enhancements include but are not limited to dramatic improvements to the recording and playback of MP3 music, enhancement to the listening experiences for movies, and improvements in general to the capabilities, performance and quality of audio and music creation.

Media player module 12 may contain media content processing devices for processing the media content to a state that can be played/outputted directly without further processing over audio output 32, 62 and/or output display 34, 64. For example, media player module 12 may contain any number of media content processing devices such as analog-digital converters, digital-analog converters, noise filters, and amplifiers. As such, the processed media content is suitable for direct playback over audio output 32, 62 and/or output display 34, 64.

Preferably, the media player module 12 is configured to enable the user to select from several surround audio enhancement effects and to control the amount of the effect to suit the users' preferences. Many of these audio enhancements are commercially available in computer sound cards provided by Creative Technologies Ltd. For example, the X-Fi soundcard provided by Creative Technologies Ltd. presently allows a user options including MultiSpeaker Surround 3D Surround, MultiSpeaker Surround 3D Headphone, MultiSpeaker Surround 3D Virtual, X-Fi Crystallizer, Dolby Digital decoder, DTS-Interactive 5.1 Encoder.

X-Fi CMSS®-3D enables a user to upgrade MP3 music and movies into surround sound with headphones or multichannel speakers. This is important because it enables a consumer to enjoy stereo MP3s and movies in surround sound created with X-Fi CMSS®-3D technology. While the present invention is intended to include the basic upmixing of stereo content, the audio enhancement module 12 is preferably configured to remix the audio intelligently to match the speaker system (including headphones).

The audio enhancement techniques that may be configured into the media player module 12 include advanced techniques to extract specific audio elements so music and movies sound more alive than ever, i.e., to add in one embodiment “punchiness”. The potential benefits when listening to or creating music are abundant. For example, static stereo music may be converted into surround sound suitable for playback over multichannel speakers. Although in one embodiment, the enhanced listening experience is provided when listening to music tracks, the invention includes other forms of media content. For example, videos or movies may be enhanced to provide surround sound over headphones or speakers. Thus, an example surround sound processing technique suitable for integration into the module to enjoy movies is the X-Fi CMSS®-3D.

Other processing techniques provided in other embodiments enable up mixing, virtualization over output channels, transient enhancement, and decoding. These are generally described with the following examples:

1. X-Fi CMSS®-3D Surround: Provides a multichannel playback for stereo music or movies.
2. X-Fi CMSS®-3D Headphone: Provides a multichannel playback experience over headphones for all types of content
3. X-Fi CMSS®-3D Virtual: Provides a multichannel playback experience over two loudspeakers for all types of content
4. X-Fi Crystallizer™—provided dynamic enhancements based on detection of transients and other energy level variations.
5. Dolby Digital decoder

### 6. DTS-Interactive 5.1 Encoder

Preferably, the media player module 12 includes at least 3D audio virtualization technologies such as X-Fi CMSS®-3D Headphone and X-Fi CMSS®-3D Virtual. These virtual technologies are designed to reproduce a natural sounding multi-channel listening experience over headphones or two loudspeakers, with both multi-channel and two-channel source formats.

In further detail, X-Fi Creative MultiSpeaker Surround 3D (CMSS-3D) is available for both rendering over headphones and speakers. Creative's CMSS®-3D Headphone technology helps the listener forget that he or she is wearing headphones, by delivering a compelling multi-channel listening experience, with any two-channel or multi-channel audio content. This is the result of the combination of three exclusive ingredients: HRTF filters, Environmental early reflections and Ambience extraction. The benefits of X-Fi CMSS®-3D Headphone include Timbre preservation; Improved externalization, frontalization and front-back discrimination. Further benefits include a natural sense of immersion, for both multi-channel and two-channel sources as well as reduced listening fatigue. Creative's CMSS®-3D Headphone technology employs advanced signal processing algorithms to place listeners in a natural, fully immersive sound field. Through these processing techniques operating with the assistance of the audio data processor 16 in the media player module 12, the auditory awareness of wearing headphones vanishes and is replaced by a transparent listening experience and the sensation of “being there”.

Creative's CMSS®-3D Virtual technology provides a convincing multi-channel listening illusion using only two loudspeakers for a listener located at the “sweet spot”, with any two-channel or multi-channel audio content. It combines the following ingredients: HRTF filters, Cross-talk canceller and Ambience extraction. The benefits of X-Fi CMSS®-3D Virtual include timbre preservation, convincing side and rear virtual loudspeaker localization, natural sense of immersion, with both multi-channel and two-channel sources. Preferably the media player module 12 is configured to provide calibration according to the placement of the loudspeakers with respect to the listener. That is, the user can control the amount of the virtualization effect to optimize the effect to adjust for the loudspeaker positions.

Transient enhancement is provided in one embodiment by Creative's X-Fi Crystallizer. This is an intelligent, automated audio-restoration processor carefully designed to bring the full benefit of audio playback to 16-bit legacy audio content. Crystallizer selectively identifies significant transients in the original 16-bit audio playback stream and dynamically enhances these to compensate for the studio mastering compromises inherent in the limited dynamic range of CD audio. The end result of applying Crystallizer enhancement depends to some extent on the details of the content to which it is applied and to the user-specified degree of enhancement. In general, though, Crystallizer produces crisper high frequencies, punchier mid-range percussion (snare drums, congas) and note onsets, and stronger kick bass hits. This audio enhancement technique is thought to be especially beneficial to listeners of compressed music such as music encoded in the mp2, wma, or ATRAC formats. This configuration is believed to enhance MP3s and movies to the point of even sounding better to many listeners than content available from the original CD or DVD. It is a low-impact algorithm designed to improve the dynamic range of an audio stream by enhancing the natural transients. The transient enhancement provided by the Crystallizer algorithms can be very effective at sharpening an audio track (particularly compressed tracks, such as MP3 files), brightening sound effects, etc. Music benefits provided include low and high frequencies are enhanced while the dynamics are improved. Movie benefits include adding realism to explosions, gun-shots and high-impact audio sequences.

In the embodiment shown in FIG. 1, only a single media player module 12 is incorporated in the portable device 10. In other embodiments the portable device 10 may be configured with any number and other types of media format processing modules.

The external device 50 includes a processor 54, memory 56 and user interface connect 58 for connecting output user interface devices 60,62,64. The external user interface devices include audio output devices 62 such as, for example, speakers, earphones, headphones and so forth. Other external user interface devices include input 60, output display devices 64 such as, for example, displays, monitors and the like.

The connector interface 20,52 and/or the user interface connect 26 may be connection ports such as USB connector interface, firewire connector interface (IEEE 1394), or the like. Connector interfaces 20 and 52 can be configured to allow bi-directional communication of different signal types (e.g., analog, digital) while using one or more cables (e.g., USB, firewire IEEE 1394) or no cables (i.e., wireless) between them. For instance, audio data sent from external device 50 to portable media player 40 can be a digital audio signal that gets processed by media player module 12 by adding audio enhancement processing and converting it into an analog audio signal for sending back to external device 50. In some embodiments, the analog audio signal is suitable for direct playback by audio output 62 without further audio processing (e.g., amplification, filtering).

When the portable device 10 is connected to the external device 50, the controller 22 and media player module 12 is powered by the external device 50 through the connector ports of the connector interfaces 20,52. Similarly, the user interface devices 30,32,34 connected to the portable device 10 are also powered by the external device 50 through the connector ports of the connector interfaces 20,52 and user interface connect 26.

When the media player module 12 of the portable device 10 is processing audio data from the external device 50, a portion of the memory 56 allocated for the processing of audio signals in the external device 50 is freed up for use by the processor 54. Consequently, processing of non-audio related tasks in the external device 50 is enhanced.

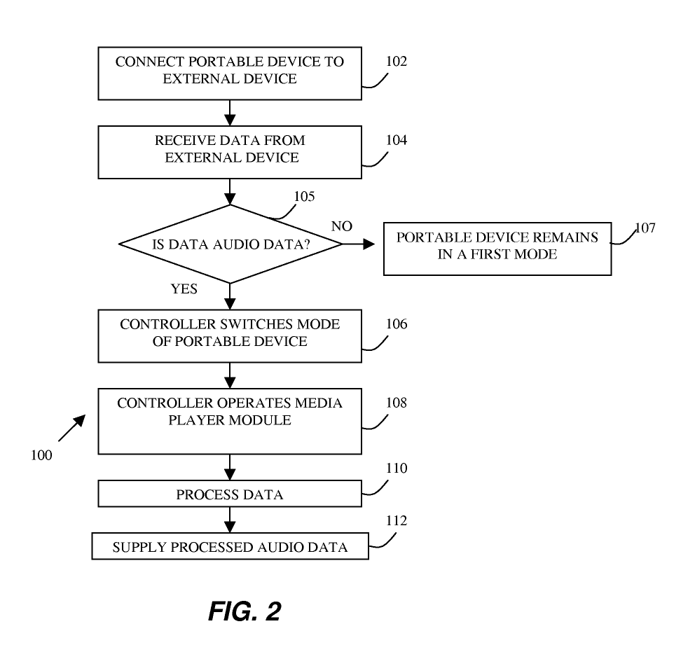

A flow chart of a method 100 of an embodiment of the invention is shown in FIG. 2. The portable device 10 is connected 102 to the external device 50. The controller 22 of the portable device 10 receives 104 data from the external device 50, and determines 105 the particular type of data. If the data is deemed by the controller 22 to be audio data, the controller 22 switches 106 the portable device 10 from a first mode as a media playback device to a second mode as an audio enhancement device. If the data is deemed by the controller 22 to be non-audio data, the portable device 10 remains in the first mode as the media playback device 107.

When the portable device 10 is in the second mode, the controller 22 operates 108 a media player module 12 to process the audio data 110. Once processed, the controller 22 supplies 112 the processed audio data to the external device 50 and/or the user interface connect 26 of the portable device 10. The external user interface devices include audio output devices 62 such as, for example, speakers, earphones, headphones and so forth. Other external user interface devices include output display devices 64 such as, for example, displays, monitors and the like.

While embodiments of the invention have been described and illustrated, it will be understood by those skilled in the technology concerned that many variations or modifications in details of design or construction may be made without departing from the present invention.

1. A portable media processing device for connecting with and enabling an external device with audio enhancement functionality, the portable device comprising:
a housing and a connector interface for connecting and exchanging data with the external device;
a media player module for processing data; and
a controller for identifying the data received from the external device and selectively controlling the media player module for processing the data from the external device and supplying the processed data.

2. The portable media processing device of claim 1, further comprising a user interface port for connecting user interface devices.

3. The portable media processing device of claim 2, wherein the user interface devices are selected from the group consisting of: speakers, earphones, headphones, displays, and monitors.

4. The portable media processing device of claim 1, wherein the media player module includes an audio data processor, and a media data processor.

5. The portable media processing device of claim 1, further comprising data storage for storing the processed data.

6. The portable media processing device of claim 2, wherein the controller supplies the processed data to either the external device or the user interface port.

7. The portable media processing device of claim 6, wherein the connector interface is either a USB connector interface or a firewire connector interface.

8. The portable media processing device of claim 7, wherein the external device is a device selected from the group consisting of: a notebook, a personal computer, a television, a mobile telephone, a games console, a camera, a CD player, and a DVD player.

9. The portable media processing device of claim 1, wherein a portion of memory allocated for the processing of audio signals in the external device is freed up for use by a processor in the external device and processing of non-audio related tasks in the external device is enhanced.

10. A method for enabling an external device with audio enhancement functionality with a portable media processing device, the method comprising:
connecting the portable device to the external device;
receiving data from the external device;
identifying the data received from the external device;
selectively controlling a media player module, the media player module configured for processing the data; and
supplying the processed data to either the external device or a user interface port.

11. A media player device for processing media content, comprising:
a controller configured to select between a first mode and a second mode, wherein the first mode is selected if audio data is absent in the media content and the second mode is selected if audio data is present in the media content, the first mode being operable to process the media content without audio enhancement processing and the second mode being operable to apply audio enhancement processing to the audio data; and
a media player module configured to process media content according to the first mode and the second mode,
wherein if the first mode is selected, the processed media content is suitable for playback on an output display, and
wherein if the second mode is selected, the processed media content is suitable for playback on an audio output device.

12. The media player device of claim 11, wherein if the second mode is selected, the processed media content is suitable for playback on the audio output device without further audio processing, which is selected from the group consisting of digital-analog conversion, amplification, and filtering.

13. The media player device of claim 11, wherein if the second mode is selected, the processed media content is suitable for playback on the audio output device without further audio processing except amplification.

14. The media player device of claim 11, wherein the media player module comprises:
a media data processor configured to process the media content for playback without audio enhancement processing.

15. The media player device of claim 11, wherein the media player module comprises:
an audio data processor configured to apply audio enhancement processing to the audio content.

16. The media player device of claim 15, further comprising:
a connection interface configured to connect to an external device, receive the media content from the external device, and transmit to the external device the processed media content if the second mode is selected, wherein the audio output device is selected from the group consisting of a speaker, an earphone, and a headphone.

17. The media player device of claim 16, wherein the connection interface is configured to allow digital and analog communication with the external device over a general purpose interconnect, the general purpose interconnect being selected from the group consisting of a USB and a firewire.

18. The media player device of claim 16, further comprising:
an user interface connection configured to receive the processed media content in either the first or second modes and connect to the audio output device and the output display for outputting the processed media content.

19. The media player device of claim 11, wherein the audio enhancement processing is selected from the group consisting of virtualization technologies and transient enhancements.

20. The media player device of claim 11, wherein the media content is selected from the group consisting of audio data and non-audio data.
